(19) United States
(12) Patent Application Publication
(10) Pub. No.: US 2024/0286619 A1
(43) Pub. Date: Aug. 29, 2024

(54) PROACTIVE DRIVING SAFETY ASSISTANCE

(71) Applicant: INTERNATIONAL BUSINESS MACHINES CORPORATION, ARMONK, NY (US)

(72) Inventors: YANG LIANG, Beijing (CN); Su Liu, Austin, TX (US)

(21) Appl. No.: 18/113,207

(22) Filed: Feb. 23, 2023

(51) Int. Cl. B60W 40/08; G06F 3/01

(52) U.S. Cl. CPC B60W 40/08; G06F 3/015; B60W 2540/043; B60W 2540/221; B60W 2540/227

(57) ABSTRACT

A method for proactively assisting a driver to avoid road driving risks. The method detects, in real-time, a current driving status of a driver in a vehicle. The method further learns a risk type of the driver based on driving history data and creates a corresponding action pattern for the learned risk type of the driver. The method further determines whether the vehicle is about to encounter a dangerous event and assists the driver to avoid the dangerous event using real-time physiological stimulation, wherein real-time physiological stimulation comprises electric muscle stimulation (EMS) and galvanic vestibular stimulation (GVS) signals. The method maps the EMS and GVS signals to muscles of the driver related to the corresponding action pattern necessary to avoid the dangerous event.

### BACKGROUND

The present disclosure relates generally to the field of cognitive computing and more particularly to data processing and dynamic stimulation of a driver's muscles to mitigate driving risks.

Driving automobiles on highways and roadways is a risky and dangerous venture. Human drivers of automobiles often lose focus, doze off, or freeze in sudden emergency driving situations.

While Americans drove less in 2020 due to the Covid-19 pandemic, the National Highway Traffic Safety Administration's early estimates show that an estimated 38,680 people died in motor vehicle traffic accidents, the largest projected number of fatalities since 2007. This represents an increase of about 7.2 percent as compared to the 36,096 fatalities reported in 2019.

Currently, there is no ideal way to preemptively prevent vehicle accidents and fatalities. Therefore, it is necessary to define a new method to solve the problem.

### BRIEF SUMMARY

Embodiments of the present invention disclose a method, a computer program product, and a system.

According to an embodiment, a method, in a data processing system including a processor and a memory, for proactively assisting a driver to avoid road driving risks. The method detects, in real-time, a current driving status of a driver in a vehicle. The method further learns a risk type of the driver based on driving history data and creates a corresponding action pattern for the learned risk type of the driver. The method further determines whether the vehicle is about to encounter a dangerous event and assists the driver to avoid the dangerous event using real-time physiological stimulation.

A computer program product, according to an embodiment of the invention, includes a non-transitory tangible storage device having program code embodied therewith. The program code is executable by a processor of a computer to perform a method. The method detects, in real-time, a current driving status of a driver in a vehicle. The method further learns a risk type of the driver based on driving history data and creates a corresponding action pattern for the learned risk type of the driver. The method further determines whether the vehicle is about to encounter a dangerous event and assists the driver to avoid the dangerous event using real-time physiological stimulation.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method detects, in real-time, a current driving status of a driver in a vehicle. The method further learns a risk type of the driver based on driving history data and creates a corresponding action pattern for the learned risk type of the driver. The method further determines whether the vehicle is about to encounter a dangerous event and assists the driver to avoid the dangerous event using real-time physiological stimulation.

### BRIEF DESCRIPTION OF THE DRAWINGS

FIG. 1 depicts a diagram graphically illustrating the hardware components of proactive driving safety assistance computing environment 200 and a cloud computing environment, in accordance with an embodiment of the present invention.

FIG. 2 illustrates proactive driving safety assistance computing environment 200, in accordance with an embodiment of the present invention.

FIG. 3 is a flowchart illustrating the operation of proactive driving safety assistance program 220 of FIG. 2, in accordance with an embodiment of the present invention.

### DETAILED DESCRIPTION

Vehicular accidents are one of the top causes of death in the world. Unfortunately, drivers of vehicles get distracted, overwhelmed, stressed, and/or fall asleep while driving. Currently, there is no effective solution to eliminate car accidents and fatalities.

Massachusetts Institute of Technology (MIT) researchers have found that, given only a single glance of the road, humans need about 390 to 600 milliseconds to detect and react to road hazards. Younger drivers detect hazards nearly twice as fast as older drivers. The present invention seeks to eliminate the 390 to 600 milliseconds of reaction time required to avoid road hazards.

It is established that biologists can control a human's muscles via electric muscle stimulation (EMS). EMS is a non-invasive technique that creates and sends a set of electric signals to one or more selected muscles in the human body, through the skin, and stimulates the muscles to move.

Another method of non-invasive electrical stimulation is galvanic vestibular stimulation (GVS). GVS produces stereotyped automatic postural and ocular responses. Depending on how GVS is applied it can produce specific sensations that may be related to the anatomy and physiology of the vestibular apparatus, including the three semi-circular canals.

GVS is the process of electrical neuromodulation of brain organs associated with balance. Targets include the nerve in the ear that maintains balance, which include two groups of receptors in the vestibular system. GVS technology has been investigated over decades for both scientific and medical purposes but is now being designed for robust and controlled stimulation.

The present invention proposes a method for proactively assisting a driver to avoid road driving risks via EMS and GVS.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

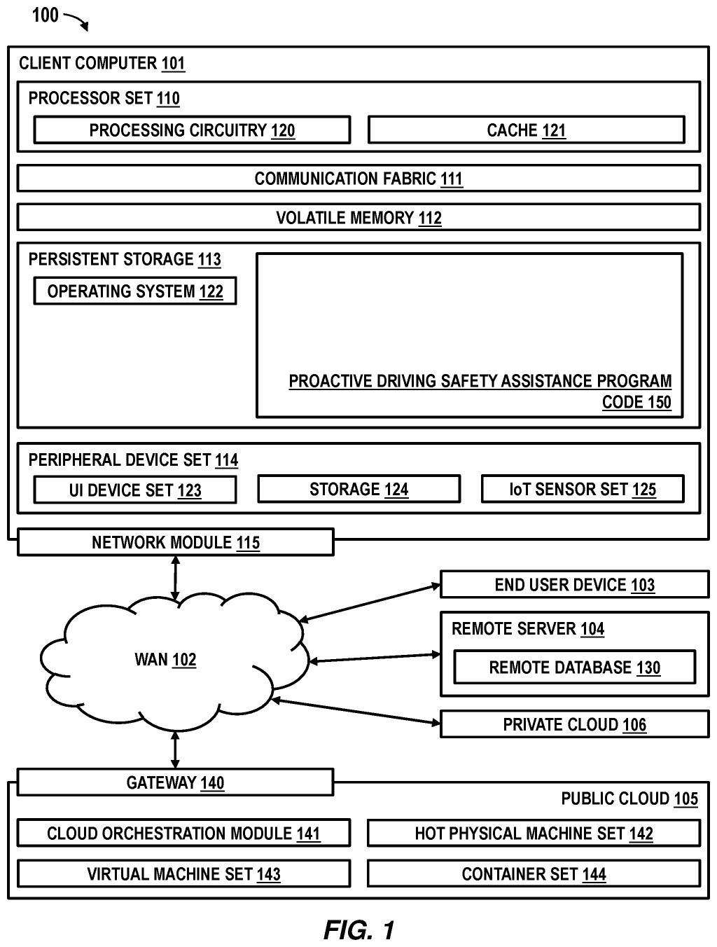

FIG. 1 depicts a diagram graphically illustrating the hardware components of proactive driving safety assistance computing environment 200 and a cloud computing environment in accordance with an embodiment of the present invention.

Computing environment 100 contains an example of an environment for the execution of at least some of the computer code involved in performing the inventive methods, such as proactive driving safety assistance program code 150. In addition to the proactive driving safety assistance program code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and proactive driving safety assistance program code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in infrared access program code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in proactive driving safety assistance program code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

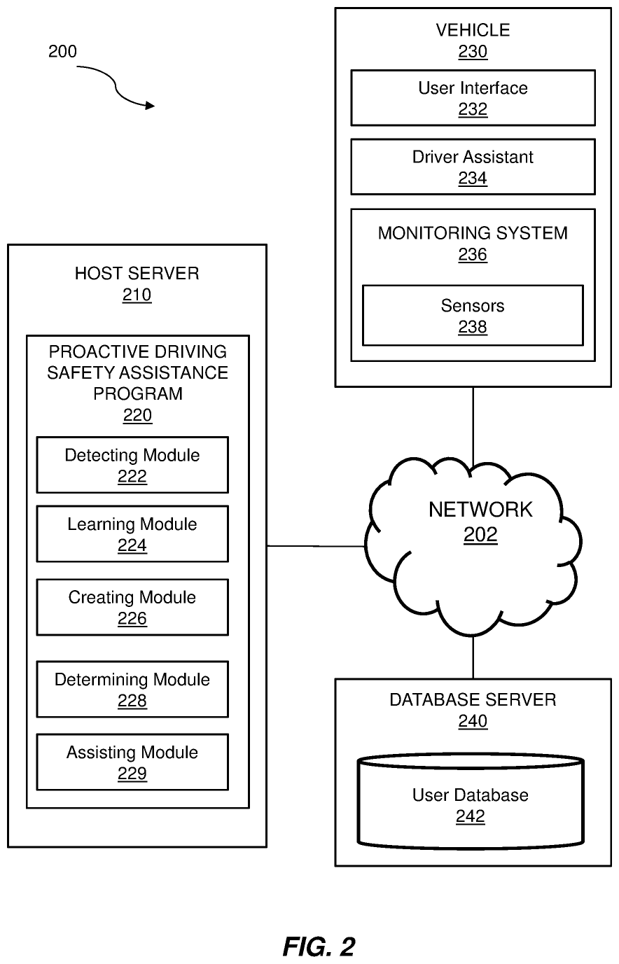

FIG. 2 illustrates proactive driving safety assistance computing environment 200, in accordance with an embodiment of the present invention. Proactive driving safety assistance computing environment 200 includes host server 210, vehicle 230, and database server 240, all connected via network 202. The setup in FIG. 2 represents an example embodiment configuration for the present invention and is not limited to the depicted setup to derive benefit from the present invention.

In an exemplary embodiment, host server 210 includes proactive driving safety assistance program 220. In various embodiments, host server 210 may be a laptop computer, tablet computer, netbook computer, personal computer (PC), a desktop computer, a personal digital assistant (PDA), a smart phone, or any programmable electronic device capable of communicating with vehicle 230, and database server 240, via network 202. Host server 210 may include internal and external hardware components, as depicted, and described in further detail with reference to FIG. 1. In other embodiments, host server 210 may be implemented in a cloud computing environment, as further described in relation to FIG. 1 herein. Host server 210 may also have wireless connectivity capabilities allowing it to communicate with vehicle 230, and database server 240, and other computers or servers over network 202.

With continued reference to FIG. 2, vehicle 230 includes user interface 232, driver assistant 234, and monitoring system 236. In exemplary embodiments, vehicle 230 may be a car, a minivan, a truck, a tractor-trailer, a train, or any road (or off-road) vehicle. In exemplary embodiments, vehicle 230 can detect outside road conditions, current operating state of vehicle 230 and driver via monitoring system 236.

In alternative embodiments, vehicle 230 may be any type of vehicle, such as a vehicle that flies in the sky (e.g., airplane, rocket ship, hot-air balloon, hovercraft, etc.), a vehicle that floats on the water (e.g., motorboat, yacht, jet ski, pontoon, freight ship, etc.), and any other vehicle, known to one of ordinary skill in the art, capable of being operated by a human.

While the present application focuses primarily on proactive driving safety assistance via a human driver's physiological state, the scope of the invention is not limited to vehicles. For example, the present invention may be used for any electronic device, gadget, machinery, hydraulics, or defined space that is operated by a human, containing a monitoring system where avoidance of dangerous conditions may be monitored and evaluated.

In exemplary embodiments, vehicle 230 includes user interface 232, which may be a computer program that allows a user to interact with vehicle 230 and other connected devices via network 202. For example, user interface 232 may be a graphical user interface (GUI). In addition to comprising a computer program, user interface 232 may be connectively coupled to hardware components, such as those depicted in FIG. 1, for sending and receiving data. In an exemplary embodiment, user interface 232 may be a web browser, however in other embodiments user interface 232 may be a different program capable of receiving user interaction and communicating with other devices, such as host server 210.

In exemplary embodiments, user interface 232 may be a touch screen display, a visual display, a remote operated display, or a display that receives input from a physical keyboard or touchpad located within vehicle 230, such as on the dashboard, console, etc. In alternative embodiments, user interface 232 may be operated via voice commands, BLUETOOTH, a mobile device that connects to vehicle 230, or by any other means known to one of ordinary skill in the art. In exemplary embodiments, a user may interact with user interface 232 to report a problem, override driver assistant 234, and/or update user preferences. In various embodiments, a user may interact with user interface 232 to provide feedback to proactive driving safety assistance program 220 via network 202.

In exemplary embodiments, vehicle 230 includes driver assistant 234, which may include one or more devices capable of sending EMS and GVS signals for stimulation of various muscles and vestibular apparatus, respectively, of a human driver, and known to one of ordinary skill in the art. For example, GVS headgear, may include skin electrodes designed for trans-mastoid stimulation and safety monitoring.

In further exemplary embodiments, driver assistant 234 may include a device that contains electrodes, known to one of ordinary skill in the art, which are applied to the skin of a human driver to send electrical impulses to target specific muscles and nerves (e.g., left leg, right leg, left arm, right arm) for corresponding movements. For example, EMS can send an electric impulse to the driver's right leg to press on the gas pedal or send an electric impulse to the driver's left leg to press on the brake pedal in vehicle 230.

In exemplary embodiments, driver assistant 234 may communicate with monitoring system 236 and proactive driving safety assistance program 220, via network 202, to evaluate and determine a physiological state of a human driver of vehicle 230.

In exemplary embodiments, vehicle 230 includes monitoring system 236, which comprises sensors 238. Sensors 238 may be a device, hardware component, module, or subsystem capable of detecting events or changes in a user environment and sending the detected data to other electronics (e.g., host server 210), components (e.g., user database 242), or programs (e.g., proactive driving safety assistance program 220) within a system such as proactive safety assistance computing environment 200. In various embodiments, sensors 238 may be located outside of vehicle 230 and inside of vehicle 230. The detected data collected by sensors 238 may be instrumental in determining whether vehicle 230, together with the driver, are in danger due to a road condition/obstruction/occurrence and/or a state of mind/condition of the driver.

Sensors 238, in exemplary embodiments, may be a global positioning system (GPS), software application, proximity sensor, camera, dashboard camera, microphone, light sensor, infrared sensor, weight sensor, temperature sensor, tactile sensor, motion detector, optical character recognition (OCR) sensor, occupancy sensor, heat sensor, analog sensor (e.g., potentiometers, force-sensing resistors), radar, radio frequency sensor, video camera, digital camera, Internet of Things (IoT) sensors, lasers, gyroscopes, accelerometers, structured light systems, vitals monitor, user tracking sensors (e.g., eye, head, hand, and body tracking positions of a user), and other devices used for measuring an environment or current state of the user and/or the physical environment of the user.

In alternative embodiments, proactive driving safety assistance computing environment 200 may include any other systems and methods for collecting and utilizing vehicle 230 data, driving status data, and driver state of mind/behavior data within an IoT system, known to one of ordinary skill in the art.

In exemplary embodiments, monitoring system 236 is capable of continuously monitoring, collecting, and saving collected data on database server 240, a local storage database, or sending the collected data to proactive driving safety assistance program 220 for analysis and storage. In alternative embodiments, monitoring system 236 may be capable of detecting, communicating, pairing, or syncing with IoT devices, thus creating opportunities for more direct integration of the physical world into computer-based systems, and resulting in improved efficiency, accuracy, and economic benefit in addition to reduced human intervention.

In exemplary embodiments, sensors 238 may further include a vitals monitor, which may be a computer program, on monitoring system 236, that detects and monitors a driver's vital signs which may include blood pressure, cholesterol levels, blood sugar levels, heart rate and so on. In other embodiments, the vitals monitor may be a separate device such as a blood glucose monitor, a heart rate monitor, or a wearable device that detects one or more of the driver's vital signs that communicates with monitoring system 236.

Monitoring system 236 may be capable of transmitting detected and monitored vital signs of a driver to proactive driving safety assistance program 220, either on a continuous basis or at set intervals. In other embodiments, monitoring system 236 may be configured to detect and monitor a driver's vital signs based on any method known to one of ordinary skill in the art.

In exemplary embodiments, monitoring system 236 may include an opt-in feature, enabling a user to set preferences (e.g., give or revoke permissions) for detection, monitoring, and storing of a user's (i.e., a driver's) vital signs and privately collected medical data.

In various embodiments, sensors 238 may be embedded within vehicle 230 and contain a computer processing unit (CPU), memory, and power resource, and may be capable of communicating with vehicle 230, database server 240, and host server 210 over network 202.

In exemplary embodiments, database server 240 includes user database 242. In various embodiments, database server 240 may be a laptop computer, tablet computer, netbook computer, personal computer (PC), a desktop computer, a personal digital assistant (PDA), a smart phone, a server, or any programmable electronic device capable of communicating with host server 210 and vehicle 230, via network 202. Database server 240 may include internal and external hardware components, as depicted, and described in further detail with reference to FIG. 1. In other embodiments, database server 240 may be implemented in a cloud computing environment, as described in relation to FIG. 1. Database server 240 may also have wireless connectivity capabilities allowing it to communicate with host server 210, vehicle 230, and other computers or servers over network 202.

In exemplary embodiments, user database 242 contains one or more sets of defined user data that correspond to learned risk types of a user, and corresponding driving history data (e.g., driving out of lane, speeding, sharp turns, etc.).

In further exemplary embodiments, user database 242 may store defined data structures for tracking road driving risks in real-time, wherein the data structure comprises a driver identifier (ID), a vehicle ID, a current position of a driver, a driving direction, a driving speed, EMS-Electrode IDs (e.g., E1, E2, . . . . En), and GVS-Electrode IDs (e.g., G1, G2, . . . . Gn).

While user database 242 is depicted as being stored on database server 240, in other embodiments, user database 242 may be stored on vehicle 230, host server 210, proactive driving safety assistance program 220, or any other device or database connected via network 202, as a separate database. In alternative embodiments, user database 242 may be comprised of a cluster or plurality of computing devices, working together, or working separately.

With continued reference to FIG. 2, host server 210 includes proactive driving safety assistance program 220. Host server 210 may be a laptop computer, tablet computer, netbook computer, personal computer (PC), a desktop computer, a personal digital assistant (PDA), a smart phone, or any programmable electronic device capable of communicating with vehicle 230, and database server 240 via network 202.

With continued reference to FIG. 2, proactive driving safety assistance program 220, in an exemplary embodiment, may be a computer application on host server 210 that contains instruction sets, executable by a processor. The instruction sets may be described using a set of functional modules. In exemplary embodiments, proactive driving safety assistance program 220 may receive input from vehicle 230 and database server 240 over network 202. In alternative embodiments, proactive driving safety assistance program 220 may be a computer application on vehicle 230, or a standalone program on a separate electronic device.

With continued reference to FIG. 2, the functional modules of proactive driving safety assistance program 220 include detecting module 222, learning module 224, creating module 226, determining module 228, and assisting module 229.

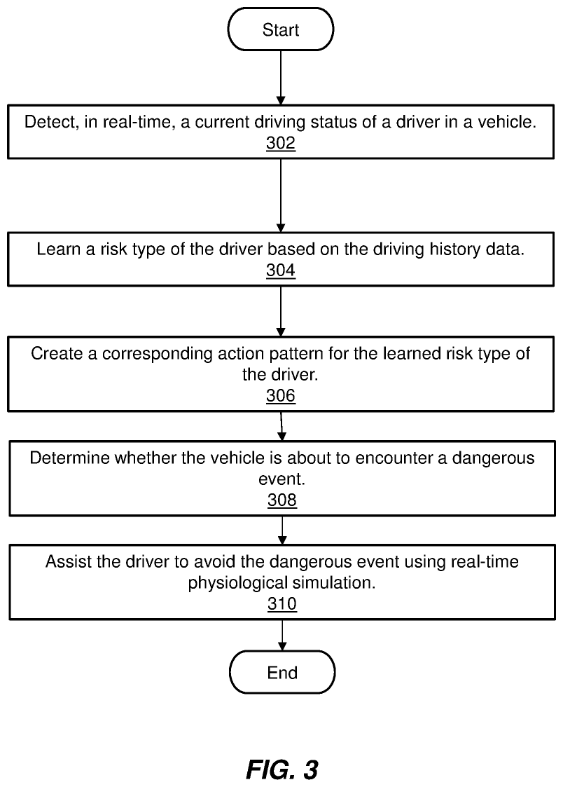

FIG. 3 is a flowchart illustrating the operation of proactive driving safety assistance program 220 of FIG. 2, in accordance with embodiments of the present disclosure.

With reference to FIGS. 2 and 3, detecting module 222 includes a set of programming instructions, in proactive driving safety assistance program 220, to detect in real-time a current driving status of a driver in a vehicle (step 302). The set of programming instructions is executable by a processor.

For example, detecting module 222 can capture, via sensors 238, a stress level of a driver, whether the driver is falling asleep behind the steering wheel, whether the driver's hands are on the steering wheel, and so forth.

With reference to an illustrative example, Joe is driving his car from Florida to New York. Joe has been driving for fifteen (15) hours without a break and he's starting to doze off. Joe's car begins veering out of his lane on the highway.

With continued reference to FIGS. 2 and 3, learning module 224 includes a set of programming instructions in proactive driving safety assistance program 220, to learn a risk type of the driver based on driving history data (step 304). The set of programming instructions is executable by a processor.

In exemplary embodiments, proactive driving safety assistance program 220 stores driving history data in user database 242. The driving history data, for each user, may be ranked based on specific instances of driving behavior that violates the rules of the road. For example, a user may speed often instead of following the posted speed limit; make sharp turns instead of slowing down prior to turning; press hard on the brakes instead of gradually stopping the vehicle; drive off lane or into the shoulder instead of driving straight in own lane; driver gets flustered and freezes up when there is an animal or object in the middle of the road; driver falls asleep at the wheel after driving three (3) hours without a break; driver only keeps one hand on the wheel while driving; driver sends text messages while driving; driver watches movies on smart device while driving; and so forth.

In exemplary embodiments, proactive driving safety assistance program 220 monitors the risk-type of the driver in real-time and evaluates the risk type of the driver in real-time.

In exemplary embodiments, a user's driving history data is saved and ranked based on specific instances of violating the rules of the road and the number of times the specific violations occur. According to the respective user's driving history data, the driver is accorded a risk type. For example, risk types may include: high-risk driver; low-risk driver; and no-risk driver.

In further exemplary embodiments, learning module 224 defines a data structure for tracking road driving risks in real-time, wherein the data structure comprises a driver identifier (ID), a vehicle ID, a current position of a driver, a driving direction, a driving speed, EMS-Electrode IDs, and GVS-Electrode IDs.

In alternative embodiments, learning module 224 may define a data structure with additional variables to assess and rank a driver's risk, based on information known to one of ordinary skill in the art.

With continued reference to the illustrative example above, Joe is a high-risk driver based on his saved driving history data. Joe drives for long hours without taking a break, he typically drives with one hand on the steering wheel, and he regularly has movies playing on his smartphone while driving. Due to his reckless driving behavior, Joe has veered out of his lane on several prior occasions, thus damaging his vehicle and others' property.

With continued reference to FIGS. 2 and 3, creating module 226 includes a set of programming instructions in proactive driving safety assistance program 220, to create a corresponding action pattern for the learned risk type of the driver (step 306). The set of programming instructions is executable by a processor.

In exemplary embodiments, a corresponding action pattern for the learned risk type of the driver may include pressing on the brake pedal, turning left, turning right, assisting the driver and or passengers towards a safe posture (e.g., protecting one's head and/or exposed areas).

With continued reference to the illustrative example above, since Joe is a high-risk driver who veers out of his lane while driving, creating module 226 counteracts Joe's behavior by creating an action pattern for Joe to keep both hands on the steering wheel and to turn the steering wheel slightly to the right when it's determined that Joe is veering out of his lane to the left.

With continued reference to FIGS. 2 and 3, determining module 228 includes a set of programming instructions in proactive driving safety assistance program 220, to determine whether the vehicle is about to encounter a dangerous event (step 308). The set of programming instructions is executable by a processor.

In exemplary embodiments, monitoring system 236 helps to gather information from sensors 238 located inside and outside vehicle 230. From the gathered sensor information, determining module 228 determines if the vehicle 230 is in danger and how to avoid the dangerous event.

With continued reference to the illustrative example above, determining module 228, with the information gathered from monitoring system 236, determines that Joe is off-lane on the highway and is rapidly approaching contact with a tree on the side of the road.

With continued reference to FIGS. 2 and 3, assisting module 229 includes a set of programming instructions in proactive driving safety assistance program 220, to assist the driver to avoid the dangerous event using real-time physiological stimulation (step 310). The set of programming instructions is executable by a processor.

In exemplary embodiments, real-time physiological stimulation includes electric muscle stimulation (EMS) and galvanic vestibular stimulation (GVS) signals.

In exemplary embodiments, proactive driving safety assistance program 220 maps the EMS and the GVS signals to muscles of the driver related to the corresponding action pattern necessary to avoid the dangerous event.

For example, if the driver needs to press hard on the brakes to avoid an obstacle directly in front of vehicle 230, assisting module 229 will send a prolonged EMS signal to the driver's right leg/foot to press the brake pedal, especially if the driver is a risk type that is slow to react in emergency situations. This EMS assistance can possibly save lives and property.

In exemplary embodiments, assisting module 229 receives feedback from the driver based on the corresponding action pattern used to avoid the dangerous event and adjusts the corresponding action pattern for the learned risk type of the driver based on the received feedback.

With continued reference to the illustrative example above, assisting module 229 via driver assistant 234, sends an EMS signal to Joe's right arm/hand to steer the steering wheel back into his lane and avoid crashing into the tree on the side of the road.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, vehicle 230, and database server 240.

1. A computer-implemented method for proactively assisting a driver to avoid road driving risks, the computer-implemented method comprising:
detecting, in real time, a current driving status of a driver in a vehicle;
learning a risk type of the driver based on driving history data;
creating a corresponding action pattern for the learned risk type of the driver;
determining whether the vehicle is about to encounter a dangerous event; and
assisting the driver to avoid the dangerous event using real-time physiological stimulation.

2. The computer-implemented method of claim 1, wherein real-time physiological stimulation comprises electric muscle stimulation (EMS) and galvanic vestibular stimulation (GVS) signals.

3. The computer-implemented method of claim 2, further comprising:
mapping the EMS and the GVS signals to muscles of the driver related to the corresponding action pattern necessary to avoid the dangerous event.

4. The computer-implemented method of claim 1, further comprising:
receiving feedback of the driver based on the corresponding action pattern used to avoid the dangerous event.

5. The computer-implemented method of claim 4, further comprising:
adjusting the corresponding action pattern for the learned risk type of the driver based on the received feedback.

6. The computer-implemented method of claim 1, further comprising:
defining a data structure for tracking road driving risks in real-time, wherein the data structure comprises a driver identifier (ID), a vehicle ID, a current position of a driver, a driving direction, a driving speed, EMS-Electrode IDs, and GVS-Electrode IDs.

7. The computer-implemented method of claim 1, further comprising:
monitoring the risk type of the driver in real-time; and
evaluating the risk type of the driver in real-time.

8. A computer program product, comprising a tangible storage device having program code embodied therewith, the program code executable by a processor of a computer to perform a method, the method comprising:
detecting, in real time, a current driving status of a driver in a vehicle;
learning a risk type of the driver based on driving history data;
creating a corresponding action pattern for the learned risk type of the driver;
determining whether the vehicle is about to encounter a dangerous event; and
assisting the driver to avoid the dangerous event using real-time physiological stimulation.

9. The computer program product of claim 8, wherein real-time physiological stimulation comprises electric muscle stimulation (EMS) and galvanic vestibular stimulation (GVS) signals.

10. The computer program product of claim 9, further comprising:
mapping the EMS and the GVS signals to muscles of the driver related to the corresponding action pattern necessary to avoid the dangerous event.

11. The computer program product of claim 8, further comprising:
receiving feedback of the driver based on the corresponding action pattern used to avoid the dangerous event.

12. The computer program product of claim 11, further comprising:
adjusting the corresponding action pattern for the learned risk type of the driver based on the received feedback.

13. The computer program product of claim 8, further comprising:
defining a data structure for tracking road driving risks in real-time, wherein the data structure comprises a driver identifier (ID), a vehicle ID, a current position of a driver, a driving direction, a driving speed, EMS-Electrode IDs, and GVS-Electrode IDs.

14. The computer program product of claim 8, further comprising:
monitoring the risk type of the driver in real-time; and
evaluating the risk type of the driver in real-time.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
detecting, in real time, a current driving status of a driver in a vehicle;
learning a risk type of the driver based on driving history data;
creating a corresponding action pattern for the learned risk type of the driver;
determining whether the vehicle is about to encounter a dangerous event; and
assisting the driver to avoid the dangerous event using real-time physiological stimulation.

16. The computer system of claim 15, wherein real-time physiological stimulation comprises electric muscle stimulation (EMS) and galvanic vestibular stimulation (GVS) signals.

17. The computer system of claim 16, further comprising:
mapping the EMS and the GVS signals to muscles of the driver related to the corresponding action pattern necessary to avoid the dangerous event.

18. The computer system of claim 15, further comprising:
receiving feedback of the driver based on the corresponding action pattern used to avoid the dangerous event.

19. The computer system of claim 18, further comprising:
adjusting the corresponding action pattern for the learned risk type of the driver based on the received feedback.

20. The computer system of claim 15, further comprising:
defining a data structure for tracking road driving risks in real-time, wherein the data structure comprises a driver identifier (ID), a vehicle ID, a current position of a driver, a driving direction, a driving speed, EMS-Electrode IDs, and GVS-Electrode IDs.
